(19) United States
(12) Patent Application Publication
(10) Pub. No.: US 2009/0222450 A1
(43) Pub. Date: Sep. 3, 2009

(54) SYSTEM AND A METHOD FOR TRANSFERRING EMAIL FILE ATTACHMENTS OVER A TELECOMMUNICATION NETWORK USING A PEER-TO-PEER CONNECTION

(76) Inventor: Ron Zigelman, Even Yehuda (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/913,772

(22) PCT Filed: May 14, 2006
(86) PCT No.: PCT/IL06/00565

§ 371 Date: Jun. 23, 2008

Related U.S. Application Data
(60) Provisional application No. 60/681,054, filed on May 16, 2005.

(51) Int. Cl. G06F 17/30; G06F 15/16

(52) U.S. Cl. 707/10; 709/206; 707/E17.01; 707/E17.032; 707/E17.014; 707/3

(57) ABSTRACT

The present invention is a new and efficient system and method for transferring large email attachment files by establishing an ad-hoc peer-to-peer (P2P) connection between sender and recipients. By separating the email from the attachment, the invention dramatically decreases the volume of data transferred by mail servers, allowing them to handle only the body of the message. The attachment files are transferred using direct communication means, which are more suitable for this kind of data transference. All the embodiments of the present invention may be implemented as software components, which can be integrated into any existing email application, or as a stand-alone application including the email and the P2P functionalities. Also included in the scope of the present invention are means for identifying additional sources in the network from which the transferred file may be downloaded, whenever the attached file is a generic file.

### BACKGROUND

The present invention relates in general to systems and methods for transferring large-scale email file attachments over a data network, more particularly it relates to transferring large-scale email attachment files using an ed-hoc peer-to-peer connection.

As the email and messaging services become more readily accessible the volume of data transferred through these mediums increases exponentially. While usually the body of the messages does not require significant storage space and bandwidth availability to transfer, most often the attached files pose a heavy burden on messaging systems. There is therefore a need for a system and a method for allowing users to easily and comfortably transfer files to other users in a safe and optimized manner. One of the means which has become particularly useful for transferring big files is the peer-to-peer (P2P) connection. The P2P connection has many advantages for transferring files since it allows the end users to establish a direct connection and transfer the files between them. Thus, the end users may also control the download parameters to their convenience.

Know in the art are several methods for combining email facilities with P2P abilities. For instance Canadian Patent No. 2,390,817 discloses a software and process that provides a moderately secure, easy to uses fully automatic and transparent means of sending and receiving email via the Internet using public-key cryptography and peer-to-peer (“P2P”) networking, without the need for the user to change the software or processes that they currently use to retrieve, read, compose and send email, and without the use of a centralized control process or store and forward system. The invention includes: a central database and server that contains information about which computers are currently using the solution; a proxy that provides message encryption and decryption services and manages the process of establishing a P2P connection between the sending and receiving systems and a validation process that provides reasonable assurance that the sender and receiver of an email message has the authority to send and receive email messages using the email addresses contained in the header of the message.

While the proposed solution disclosed in Canadian Patent No. 2,390,817 addresses some of the problems mentioned above, it still has several drawbacks. First, it does not offer a fully secure manner for transferring classified files. Second, it does not offer methods for optimizing the transference of the file, thus, if the sender and recipient do not manage to synchronize their connectivity time, the file transference may be delayed. Finally, this solution does not offer optimized methods whenever the attached files are addressed to a few recipients simultaneously.

Additionally, one of the major problems of current-day emailing services is that a large portion of the volume of data sent over the emails contains generic files—files which were not created by the sender and which may be found in different locations in the network. People like to send their friends video clips, images, presentations and audio segments which they found on the web or received from other users. Similarly, since most often the content of these mail messages is not personal or directed towards a particular person, users tend to send these messages to large numbers of recipients. While most of these files may be found in different locations on the network, most often the senders do not simply send their recipients the link of the location from which the file may be downloaded, hut send the actual file. This occurs since often having received the files as email attachments themselves, the senders do not know where to find a link to the location where the file is already stored.

According to prior art several solutions have been found for addressing the above mentioned problem. For instance, US Patent Application 20020059384 discloses a service on a data network which verifies if an attachment to a email to a sender has a copy of an electronic document available from a source on the data network. If the document is available from this source, the service strips the attachment from the e-mail body and replaces it with a URL to save bandwidth and storage space. However, this invention provides only a limited solution to this problem: it does not offer extensive means for locating the desirable file on different networks, such as P2P networks, it does not offer means for optimizing the searching mechanism for retrieving the location of the files in the network and it does not enable downloading the file from multiple locations for maximizing the download capacity.

There is therefore a need for a system and a method which would enable users to send medium to large files using their email facilities without burdening traditional email servers and optimizing transference time. The proposed system and method should offer a fully secure and automatic solution which may be transparent to the user. Additionally, the proposed solution should be able to identify files which may be downloaded from multiple sources to ensure optimization of file transference.

### SUMMARY

Disclosed is a method for sending a file attachment of electronic message between at least two users, while the body of the message is sent through traditional messaging procedures. The method comprises the step of sending the attachment through direct peer connection between at least one IP node holding at least part of the file attachment and the receiver. The required details for the direct peer connection are installed within the message itself. The method also includes the step of composing hash values of the file, whereas said function serving as file ID of the attached file and is included within the transferred file details. The attached file may also be compressed. The file transfer technique may be determined in accordance with file size.

The method may transfer only partial parts of file when segments of the content of the attached file are already stored in the receiving user computer or on the IP network. Updates of the network connectivity details of the sender are transferred until the file transfer is complete. The segmented parts of the file may be sent to different recipients, wherein the recipients are able to share file segments between themselves. The method may include the step of establishing direct communication between the users, not requiring temporary storage of the attachment content other than at the local computers of the users.

In different instances an ad hock connection path between the two users may be found. In such cases parts of the content may be stored on at least one intermediating IP node (“supernode”), and the finding process is preformed by end users applications. The supernodes are chosen according to different criteria in order to optimize the transferring procedure. These criteria may include file type, file size, connectivity parameters or availability. At least one of the users may be a mail server. Connection may be established with organized peer to peer networks, enabling the downloading of file from said networks.

The electronic message may be viewed by the recipient through designated application software. The received file may be displayed as an attachment of the electronic message within the GUT application. A preview utility of file content may be provided. The preview is available before the file is downloaded o the recipient user computer in its entirety.

The file attachment may be identified as a generic file which is uploaded from an external source other than the sending user. The generic attached file may be located within an IP network. For this purpose an URL address lookup database may be created, the addresses link to identify content files. The process of creating an URL address lookup database, may include the steps of: exploring through users local memory for identifying relevant URL addresses of content file which were downloaded from the internet; creating bash value identifiers of each content file; periodically transmitting updates of identified URL to at least one central server; maintaining an updated lookup database of active URL links, each link is associated with at least one hash value identifier. This database is accessible to users which search specific files for transferring files through the Internet. The files may be filtered in accordance with file types or file sizes. The data may be collected and transferred at predetermined intervals according to dynamic parameters. The URL address lookup database may be searched in accordance with file identifiers, and a wish list of files not located within said URL address lookup database may be created accordingly. An automatic search mechanism for locating high rated files within the wish list may be applied. The URL lookup database may be distributed among peers of an JP network. The distribution of the data is preformed hierarchically in accordance with communication optimization rules.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein—

FIG. 1 is a schematic block diagram illustrating the first embodiment of the present invention;

FIG. 2 is a block diagram illustrating the network identification information retrieval mechanism using a P2P server according to the first embodiment of the present invention;

FIG. 3 is a block diagram illustrating the network identification information retrieval mechanism via the P2P network according to the first embodiment of the present invention;

FIG. 4 is a block diagram illustrating the file transference of a single file to a plurality of destinations according to the first embodiment of the present invention;

FIG. 5 is a block diagram illustrating the file transference of a single file to a plurality of destinations using multicasting in accordance with the first embodiment of the present invention;

FIG. 6 is a block diagram illustrating a generic file transference using a plurality of sources in accordance with the second embodiment of the present invention;

FIG. 7 is a block diagram illustrating a generic file transfer using a host server according to the second embodiment of the present invention;

FIG. 8 is a flowchart illustrating the sending procedure of the present invention;

FIG. 9 is a flowchart illustrating the receiving procedure of the present invention;

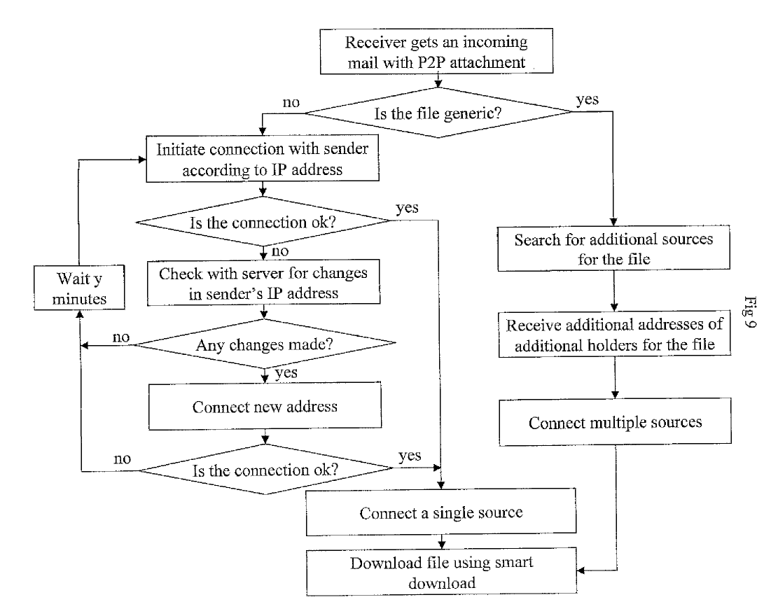

FIG. 10 is a block diagram illustrating transmission of file information in temporary internet files folders according to the second embodiment of the present invention.

### DETAILED DESCRIPTION OF THE PREFERRED EMBODIMENTS

The present invention is a new and efficient system and method for transferring large email attachment files by establishing an ad-hoc peer-to-peer (P2P) connection between sender and recipient. By separating the email from the attachment, the invention dramatically decreases the volume of data transferred by mail servers, allowing them to handle only the body of the message. The attachment files are transferred using direct communication means, which are more suitable for this kind of data transference. All the embodiments of the present invention may be implemented as software components, which can be integrated into any existing email application, or as a stand-alone application including the email and the P2P functionalities.

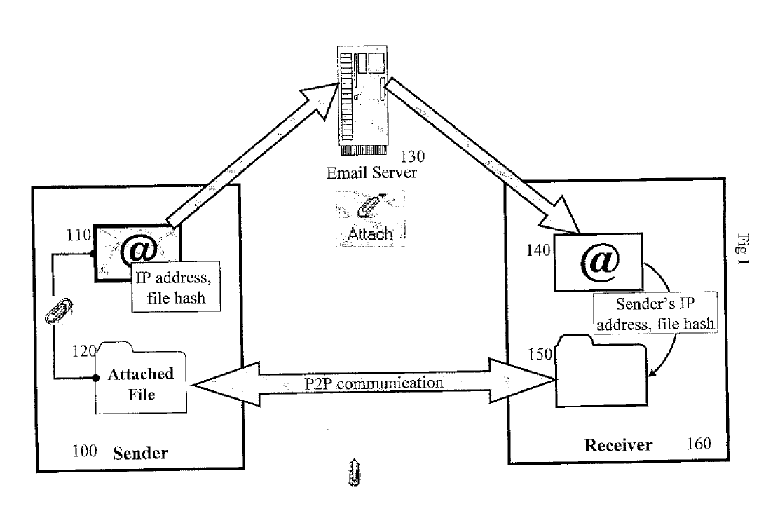

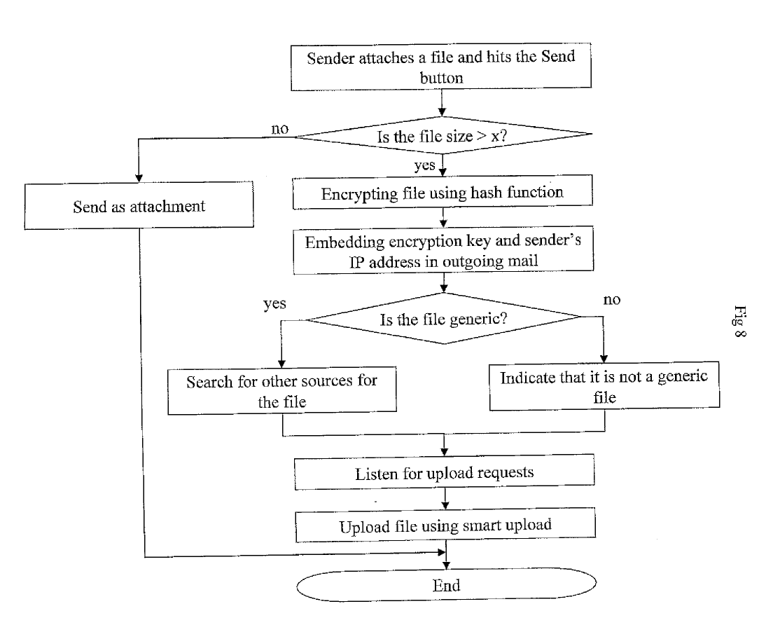

The principle components of the first embodiment are illustrated in the block diagram of FIG. 1, the flowchart of FIG. 8 illustrates the method of operation according to the first embodiment. The sender (100) composes an email (110) and attaches a file to it (120). As the sender attaches a file, or as the sending procedure is initiated, the system performs several steps. The system checks the size of the attached file; the system may be configured to send only files which are greater then a certain size, since small attachments do not burden the email servers. Provided that the file size is smaller then the predetermined value, the attached file is sent with the email in the conventional manner. If the attached file is greater then the predetermined value, or if the user chooses to send it through a P2P connection, and not through Simple Mail Transfer Protocol (SMTP) servers for security reasons, the file is not sent as an attachment, and the system incorporates into the body of the email all the necessary information for transmitting the file using a direct P2P connection. The file itself may be encrypted to ensure the security of its content; the file may also be compressed, if compression is found to be beneficial. To increase the level of security of the transmitted file, the file may be divided into segments and each segment of the file may be encrypted using a different key. Before sending the email, the system executes a hash functions to compose at least one hash value of the file details, file content or a combination thereof. These hash values operate as a unique file identifier while ensuring the security and confidentiality of the file details. Second, it extracts the network identification information of the sender. The system then discretely includes this information in the outgoing email (110) as an attachment or as part of the header of the email message (110). The email is sent without the attachment to its recipient (160) via standard emailing methods, through the email server (130).

The receiver (160) of the email receives the body of the email (140) in the conventional way, and is notified that the email attachment file is waiting to be downloaded. The recipient (160) may configure the system to automatically download any attachments of incoming emails, to wait for a download command from the user, or define selective downloads criteria such as automatic download from certain users or according to size and so on. Additionally, the user may select downloading criteria to maximize time download efficiency, such as downloading when the computer is in idle state, maximizing bandwidth use, maximizing download speed and the like, according to the attributes of the downloaded file as they are identified by the system. The download procedure may make use of different download methods, and use of different corruption data identification and repairing methods such as Tiger Tree Hash (TTH).

Once the download command is given to the system, it initiates a P2P connection with the sender (100), using the network identification information in the email. Provided that the recipient (160) already has a copy of the original file (120), the system may compare the two files and transfer only the parts of the file which were changed. Alternatively, the sender (160) may choose to identify which parts in the original file were changed to send only the modified sections of the file (120). If the files are found to be completely identical, the system may send the sender (100) a notification saying that the recipient already has a complete copy of the file. Similarly, the sender may receive a notification when the file is successfully downloaded by the recipient. When direct communication may not be established for any reason, such as when network address translation (NAT) is used, the connection may be established using a server which routes the traffic. Additionally, during the downloading procedure, the second client 1030 may preview segments of the file which where already downloaded and decide whether he or she wishes to continue with the download procedure. Having downloaded the file, the system may attach the file to the original message on the computer of the recipient. Thus, the full procedure may be totally transparent for the recipient.

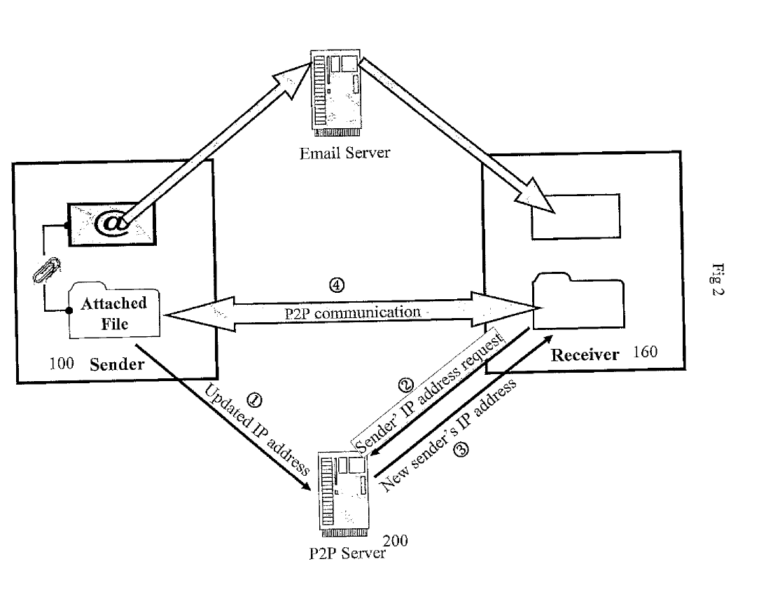

FIG. 2 is a block diagram illustrating the network identification information retrieval mechanism. The network identification information may be the IP address, internal transmission control protocol (TCP) port, internal User Datagram Protocol (UDP) port, external IP address, external TCP port, external UDP port, flags to indicate if the user can accept incoming requests and the like. Since IP addresses and ports may be dynamically allocated, the network identification information of the sender may change by the time the recipient attempts to initiate the P2P connection. In such cases, the attempts of the recipient (160) to connect to the sender (100), using the original network identification information, would fail. To avoid data loss in such cases, the system incorporates a P2P server (200). Whenever the sender detects that its network identification information has changed, it sends an encrypted message to the P2P server (200) of its new network identification information. As the recipient (160) detects that its attempts to connect the sender (100) using the network identification information in the email failed, it connects the P2P server (200) and checks whether the network identification information of the sender has changed. This query is made using the email address, the username or user ID of the sender. The P2P server (200) then sends the correct network identification information to the recipient (160), which may then initiate a P2P connection with the sender (100).

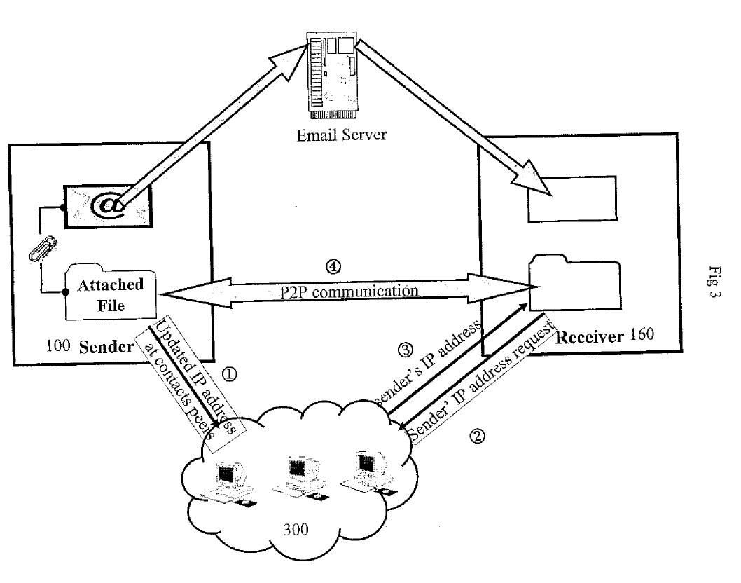

A similar procedure, which is preformed without relying on a central P2P server, is illustrated in FIG. 3. Whenever there is a change in the network identification information of the sender 100, the system sends the updated network identification information to other peers in the P2P network 300. In this case the receiver (160) sends a query to the P2P network (300) as for the updated network identification information of the sender, and receives the information from it. This procedure is performed during the handshake stage in which the system ensures that the user found using the network identification information is the same as sender 100.

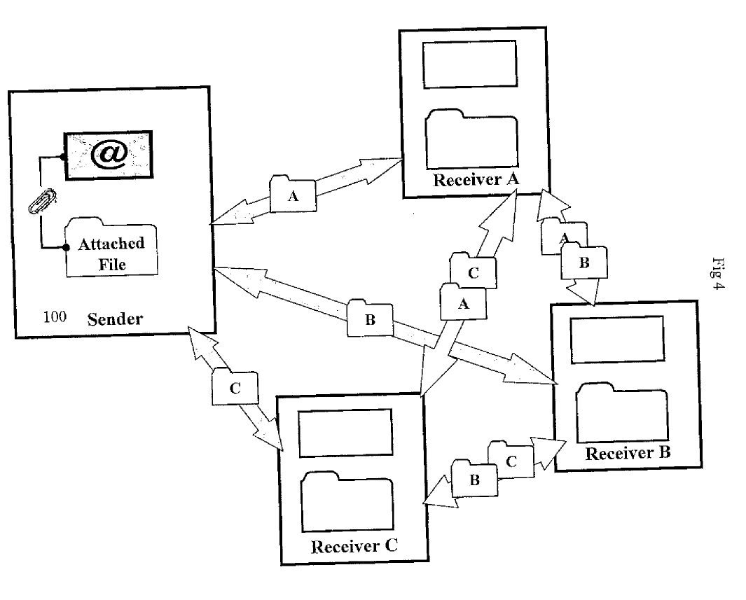

In many cases a single file needs to be sent to more then one recipient. In such cases it would be advantageous to optimize the P2P file transference between the different recipients to avoid having the different recipients compete for the limited upload bandwidth of the sender. This option may be used when the recipients do not prohibit sharing their network identification information for any reason. FIG. 4 is a block diagram illustrating the file transference procedure in such cases. If there are n recipients, the system divides the original file into n parts and destines each part for a different recipient. The email file is sent to all recipients as described above. As recipient A connects the sender (100), it downloads its portion of the original file. Provided that other recipients allow sharing their network identification information, at the same time recipient A receives from the sender (100) or from the network information about recipients B and C their network identification information and their download status. If for instance, recipient C has already started downloading its share of the original file, recipient A attempts to connect and download that segment directly from recipient C. If after a predetermined time span certain recipients still have not downloaded their segments of the file, recipients can download the missing segments from sender (100) or from network supernodes which also holds the missing segments of the file.

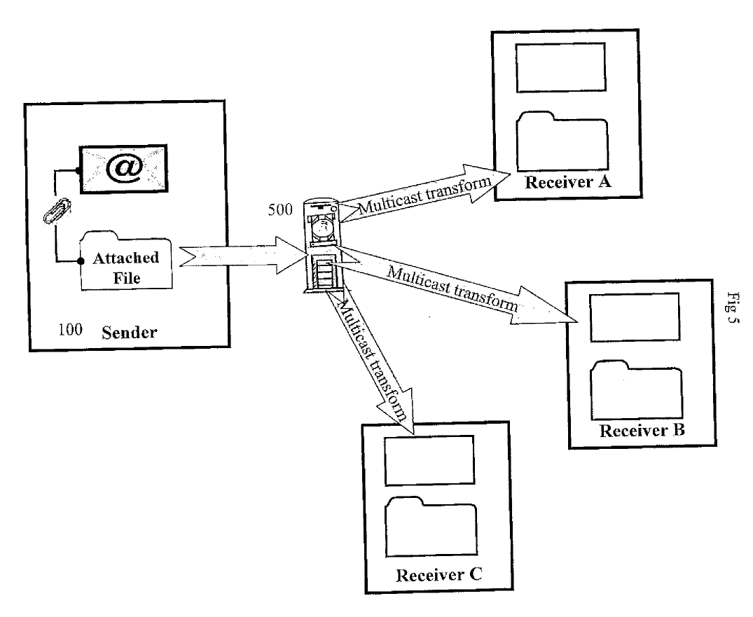

An alternative method for sending a single file to a plurality of recipients is illustrated in FIG. 5. According to this method, the transference of the original file from the sender (100) to the different recipients is performed using multicasting communication methods. In this case, a central router 500 is used to manage the communication between the sender and the recipients.

Also within the scope of the present invention is another method for transferring a file from the sender to the recipients which applies for non-confidential files. The sender may acquire storage space in a designated server or on any other accessible location. In such cases, the system transfers the file to that location as the email is sent from the sender. In the body of the email the recipient receives the information necessary for retrieving this file from that location and the file in its entirety or segments of the file may be downloaded from there. This information may also be attached to the hash value of the file in the link sent to the user, and the recipient may independently search for sources from which the file or segments of the file may be downloaded. The file may be deleted from storage after all recipients have downloaded the file, after the file has not been searched for a predetermined time period or after the system identifies that there are sufficient alternative sources for downloading the file. Similarly, storage space may be allocated for the file, or for segments of the file, on other supernodes on the network. The system ensures that performing as a supernode does not interfere with the normal operation of the sender. The system may, for instance, enable the operation of the client as a supernode when the client is not in use or not using the full processing and communication resources, provided that it does not interfere with the normal operation of the user. The recipients may then download the file in its entirety or segments of the file from those supernodes. According to this method, the supernodes may be chosen according to different criteria such as their proximity to the sender, recipient or their upload bandwidth availability, in order to optimize the download procedure of the recipient. Similarly, the communication path connecting the supernode and the user may be optimized. The optimization process may be managed through a centralized communication server, or in a distributed manner by the end users and supernodes themselves.

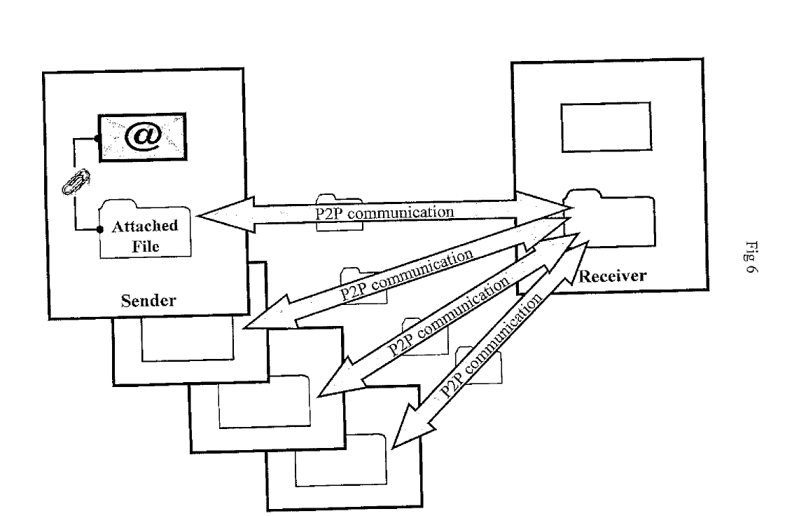

The second embodiment of the present invention relates to email messages whose attachment file is generic. Generic files are files which were not necessarily compiled by the sender, and additional copies of the same file may be found at other locations on the internet. The file may be marked as generic by the sender, or identified as such by the system. The system may identify that the file is generic by locating additional copies of the same file or segments of the file in the network. In both cases there are two methods of performing the sending procedure according to the second embodiment. The first, which is illustrated in FIG. 6, allows the recipient to download the file from a plurality of locations using multiple P2P connections. In this case the system searches for other sources which hold segments of the file or hold copies of the file, and the recipient establishes a P2P connection with them and simultaneously downloads the file from the different locations. This option allows the system to operate as an extended P2P network, enabling users to search for unclassified generic files which are circulating in the system, and not just for files which were addressed to them in particular. In addition, the system may also extend its search for sources for the file to other P2P networks.

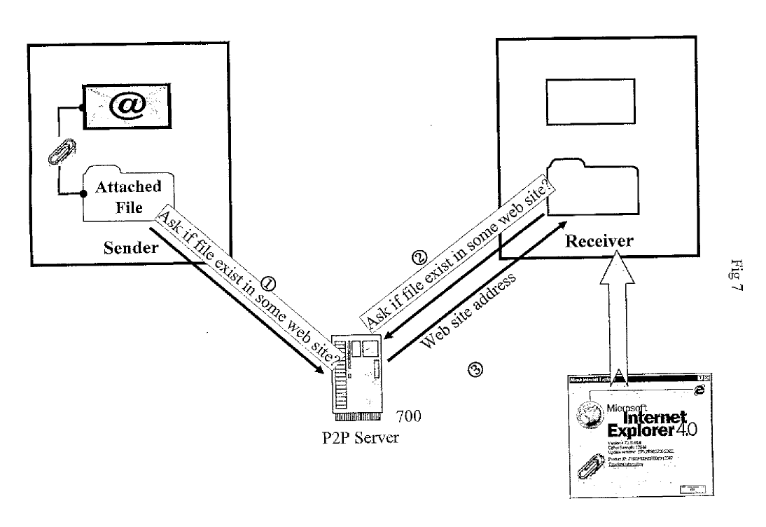

The second method, which is illustrated in FIG. 7, allows the recipient to download the file or segments of the file from a server. The network address of the server holding the file is found by the P2P server 700. Once the file is identified as generic, the application on the side of the sender or on that of the recipient asks the P2P server 700 to search the web for a server holding the file and retrieve its network address, such as the URL address. Similarly, the search may be conducted in a distributed manner through the peers of the system. The recipient then downloads segments of the file or the file in its entirety directly from that location.

Also within the scope of the present invention is a method for collecting data from the temporary internet files folders of clients and holding it in a network lookup server. According to the preferred embodiment of this method a software component which is located on the client computer manages the operation of the transference of the data to the network lookup server. The software component selectively collects data from the temporary internet files folder of its host client computer. The software component may be programmed to filter the files and collect data only about specific file types, file sizes or any other criteria. These criteria may be changed by the user of the client computer or remotely by a central managing unit. The software component may be programmed to collect and transfer the data at predetermined intervals, in response to a local or a remote command, or according to dynamic parameters. For instance, the software component may be programmed to collect and transfer the data only when its host client is in idle mode. The operation of the software component on the client computer is comprised of collecting data about the relevant files from the temporary internet files folder according to the file filer definitions; exercising hash functions on the file to produce hash values of the file; attaching the specified network source of the file, as it is specified in the temporary internet files folder, to its hash value; and sending this information to the network lookup server.

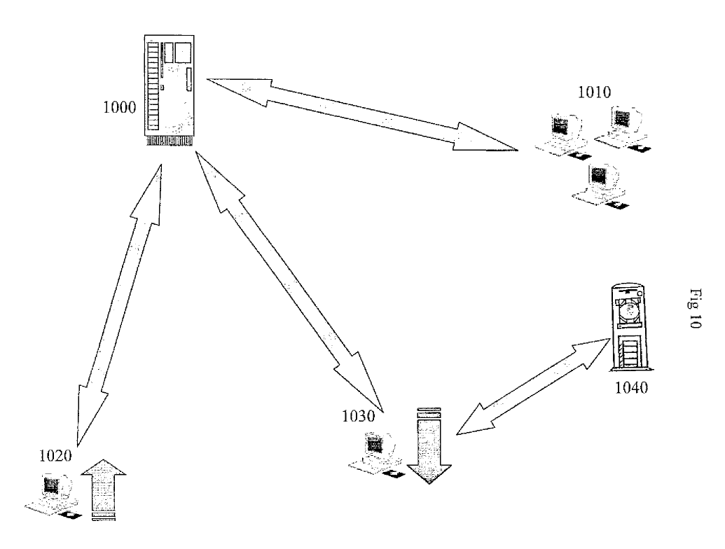

On the basis of this method an additional implementation of the method illustrated in FIG. 7 is illustrated in FIG. 10. According to this implementation the network lookup server 1000 collects from different clients 1010 the lists of files which are located in their temporary internet files folder. The network lookup server 1000 updates its generic file database with the information gathered from the temporary internet files folders of clients 1010. The network lookup server 1000 collects all the hush values of each generic file in addition to the network address of the server 1040 from which the file was downloaded as it is recorded in the temporary internet file folders of clients 1010.

Additionally, the database in network lookup server 1000 may be built using an automatic searching mechanism such as web crawler or a robot. The automatic searching mechanism receives a list of files which have been recently looked for and which are not in the network lookup server 1000. The automatic searching mechanism particularly focuses on files which are in high demand by the users of the system and which the system was not able to easily locate. Having found the files or segments of the file the automatic searching mechanism stores the link to the location where the files or file segments are found in the database of network lookup server 1000.

As the first client 1020 sends the second client 1030 an email message containing the generic file, according to the procedure described in the second embodiment of the present invention, the network lookup server 1000 searches for the file in its generic file database, for a file whose hash value matches that of the sent file. By comparing the hash values of the files, the network lookup server 1000 can ensure a positive identification of several copies of the same generic file which are located on different servers 1040. Provided that the file is found in the database of the network lookup server 1000, the network lookup server 1000 informs the first client 1020 that the file was found and therefore it does not have to be uploaded. Then, the attached file is replaced by a smart link to the server 1040 from which the file may be downloaded. The smart link may include several functions and activates the full functionality of the system on the recipient's end. Thus, it may include several hash values of the file, activate the searching mechanism and downloading procedures as well as adding the downloaded file as an attachment to the original email message.

The second client 1030 then downloads the file directly from the server 1040. Provided that there is more than one location which holds the generic file, the second client 1030 may download different segments of the file from different locations to improve download parameters. The download process is fully flexible, for instance, additional download sources may be identified and added during the downloaded procedure.

After the download attempt is completed, the second client 1030 informs the network lookup server 1000 whether the download was successful or not. Additionally, the second client 1030 may also inform the network lookup server 1000 as for download speed and the quality of the downloaded file. If the download attempt proved to be unsuccessful for some reason, e.g. the generic file was not found in a designated network address or of connectivity difficulties, or if the file is not found to be identical to its hash value, the network lookup server 1000 updates its generic file database to update or omit dead links. Provided that there is more than one server 1040 holding the same generic filer the generic file database in network lookup server 1000 may also include a rating system for the network addresses, providing users with the best server 1040 which would ensure optimization of the download procedure of the generic file.

Different options of the downloading procedure are illustrated in general terms in the flowchart of FIG. 8. For both downloading and uploading the users may define their preferences, giving specific remote users and tasks priority over other, scheduling the operations and allocating download and upload bandwidths.

The disclosed system does not only allow users to send single files, but also to send libraries containing many directories and files. During the data transference procedure, the system handles the library in the same manner as it handles a single file, but once it is received at the recipient's end in its entirety, the system reconstructs the internal organization of the library according to its original structure. Alternatively, the system may search for alternative sources of particular files inside the library, and reconstruct the structure of the original library when all files are downloaded.

In addition to being used as a system and a method for transferring files while sending an email, the disclosed methods of file transference may also be used for any other situations in which users wish to transfer files between different clients or when a user wishes to download files to a client computer from the internet. When transferring flies between different clients, using any file transfer means, the proposed system may replace the transferred file with the smart link, which includes the hash value of the file, to sources from which the second client may download the file, provided that predefined conditions are met. Additionally, a user wishing to improve the download capacities while downloading a file from a server may query the network lookup server for alternative networks from which the file may be downloaded. Alternatively, the client may receive the hash values of the file from the network lookup server. Having obtained the hash values, the user may then attempt to download the file from other servers or using other methods of downloading files such as using different peer-to-peer applications. For this purpose the network lookup server may hold different hush values for the same files whereas each hush function is compliant with a different file transfer lookup protocol, such as sha1 or md5.

All service described above can be implement both at the side of the client, on the side of the service provider or any combination thereof. Additionally, the system may be implemented to operate between different mail servers to improve the communication between them and decrease the volume of transferred data. For this purpose before sending each file the mail servers may verify that the file does not already exist on the receiving mail server. This may significantly reduce the volume of data transferred since it would eliminate the transference of duplicate files.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for sending a file attachment of electronic message between at least two users, while the message is sent through traditional messaging procedures, said method comprising the step of sending the attachment through direct peer connection between at least one IP node holding at least part of the file attachment and the receiver, wherein the required details for the direct peer connection are installed within the message itself.

2. The method of claim 1 further comprising the step of activating a hash function of the file, whereas said function result serving as file ID of the attached file and is included within the transferred file details.

3. The method of claim 1 further comprising the step of compressing the attached file.

4. The method of claim 1 further comprising the step of determining the file transfer technique in accordance with file size.

5. The method of claim 1 further comprising the step of transferring only partial parts of file when segments content are already stored in the receiving user computer.

6. The method of claim 1 further comprising the step of transferring only partial parts of file when segments content are already stored on the IP network.

7. The method of claim 1 further comprising the step of transferring updates of the network connectivity details of the sender until the file transfer is complete.

8. The method of claim 1 further comprising the step of transferring segmented parts of the file to different recipients, wherein the recipients are able to share file segments between themselves.

9. The method of claim 1 wherein direct communication is established between the users, not requiring temporary storage of the attachment content other than at the local computers of the users.

10. The method of claim 1 wherein when direct communication can not be established between the users, further comprising the step of: finding an ad hock connection path between the two users, wherein parts of the content is stored on at least one intermediating IP node (“supernode”), and the finding process is preformed by end users applications.

11. The method of claim 10 further comprising the step of choosing the supernodes according to different criteria in order to optimize the transferring procedure, wherein said criteria is one of the following: file type, file size, connectivity parameters or availability.

12. The method of claim 1 wherein at least one of the users is a mail server.

13. The method of claim 1 further comprising the step of establishing connection with organized peer to peer networks, enabling the downloading of file from said networks.

14. The method of claim 1 wherein the electronic message is viewed by the recipient through designated application software, further comprising the step of presenting the received file as an attachment of the electronic message within the GUI application.

15. The method of claim 14 further comprising the step of providing preview utility of file content, wherein the preview is available before the file is transferred to the recipient user computer in its entirety.

16. The method of claim 1 wherein the file attachment is a generic file which is uploaded from an external source other than the sending user, further comprising the step of locating the attached file within an IP network.

17. The method of claim 16 further comprising the step of creating an URL address lookup database, said addresses link to identify content files.

18. The method of claim 17 wherein the process of creating an URL address lookup database, include the steps of:
exploring through users local memory for identifying relevant URL addresses of content file which were downloaded from the internet;
creating hash value identifiers of each content file;
periodically transmitting updates of identified URL to at least one central server;
maintaining an updated lookup database of active URL links, wherein each link is associated with a hash value identifier, wherein said database is accessible to users which search specific file for downloading from the Internet.

19. The method of claim 18 further comprising the step of filtering the files in accordance with file types or file sizes.

20. The method of claim 18 further comprising the step of collecting and transferring the data at predetermined intervals according to dynamic parameters.

21. The method of claim 18 further comprising the step of: searching said URL address lookup database in accordance with file identifiers, and creating a wish list of files not located within said URL address lookup database in accordance with file identifiers.

22. The method of claim 18 further comprising the step of applying an automatic search mechanism for locating high rated file within the wish list.

23. The method of claim 18 where the URL lookup database is distributed among peers of an IP network, wherein the distribution of the data is preformed hierarchically in accordance with communication optimization rules.
